(19) United States
(12) Patent Application Publication
(10) Pub. No.: US 2003/0130861 A1
(43) Pub. Date: Jul. 10, 2003

(54) System and method for estimating service oriented labor costs

(75) Inventor: Thomas Lee Seitz, Austin, TX (US)

Correspondence Address: Joseph T. Van Leeuwen, P.O. Box 81641, Austin, TX, 78708-1641, US

(73) Assignee: International Business Machines Corporation, Armonk, NY

(21) Appl. No.: 10/042,489

(22) Filed: Jan. 9, 2002

(51) Int. Cl. G06F 17/60

(52) U.S. Cl. 705/1

(57) ABSTRACT

A system and method for managing capacity of professional and technical services is presented. A customer request is received resource types are determined with corresponding service levels to satisfy the customer request. Labor rates are generated according to service levels, or urgency levels of the customer request. Labor rates are influenced by two primary cost drivers which are resource utilization and resource overtime amount to satisfy the customer request. A customer bid is generated using the labor rates by service levels and adding non-labor cost and profit.

### BACKGROUND OF THE INVENTION

1. Technical Field

The present invention relates in general to a system and method for estimating service oriented labor costs. More particularly, the present invention relates to a system and method for providing detailed labor costs corresponding to an urgency level in order to more accurately plan, measure, and manage a labor pool.

2. Description of the Related Art

Companies experience unprecedented pressure to provide quality service at reduced prices. Companies continuously search for ways to achieve these two seemingly contradicting goals. A company may reduce prices too much which decreases profit if operating costs are not reduced accordingly. Some companies reduce headcount in order to maintain profit margins. However, headcount reduction many times decreases quality of service to customers.

Companies are encouraged to have a clear understanding of labor costs in order to effectively respond to customer requests. When a company understands the cost of performing a particular customer request, the company may successfully bid on the request and know the profit gained if the company wins the business.

Companies may choose to “low ball” a customer request in order to win business. For example, a new company attempting to enter a marketplace may bid on customer requests at “cost”, or without making a profit in order to be the lowest bidder and win the business.

In order to effectively “low ball” a request, the new company should understand its operating costs. Otherwise, the company may under bid a customer request and lose money. A challenge found is determining detailed labor rates in order to understand actual operating costs.

Labor rates are typically categorized by skill levels. For example, a senior technician may have one standard labor rate, while a junior technician may have a different standard labor rate. Standard labor rates, however, lack detail to accurately determine labor costs for bidding on a particular level of service, or level of urgency.

The urgency of a customer request directly affects the actual cost of responding to the customer request. For example, if a customer requires a service completed within one business day, a senior technician may be delegated to that request and may work overtime in order to finish the service within one business day.

On the other hand, when a customer requires a service completed within one week, the senior technician may work on multiple customer requests reducing his unapplied hours and may not work overtime. A challenge found is accurately tracking labor costs corresponding to a customer requested service level.

What is needed, therefore, is a way to accurately bid on customer requests that fluctuate in the level of service.

### SUMMARY

It has been discovered that accurate bidding on customer requests is achieved by generating labor indices by service level and applying them to standard labor rates. The result is multiple labor rates by service level that accurately accounts for various customer levels of urgency.

A customer request is received and resource types are determined to perform the corresponding service. Assuming that the resource types are available, corresponding labor indices by service levels are calculated and applied to standard labor rates which results in labor rates by service levels. Profit and non-labor costs are added, and a bid is sent to the customer.

Labor indices by service level are calculated using two fundamental inputs which are utilization indices and overtime indices. Utilization indices correspond to the utilization of a service level for a particular platform. Overtime indices correspond to the increase or decrease in the amount of overtime for a particular service level.

Utilization indices by service level are calculated using two primary inputs which are utilization weighting and utilization improvement. Utilization weighting is an averaging factor for determining utilization indices for each service level. Utilization improvement is an increase in applied/billable hours. For example, a business may spend 100 hours on a project, but the business is only able to bill 60 hours (60% utilization). If they are to bill 65 hours (65% utilization) using a particular service level, the utilization improvement is 5%.

Overtime indices by service level are calculated using two primary inputs which are max rate mix plan and overtime labor factor. Max rate mix plan is an averaging factor based on estimated overtime indices for each service level. Overtime labor factor corresponds to the increase or decrease in the cost of overtime for a particular service level.

Utilization indices by service level and overtime indices by service level are principal factors in generating labor indices by service level. Labor indices by service level are then applied to standard labor rates to generate labor rates by service level which are used to generate customer bids.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a flowchart showing steps taken in processing a customer request and responding to the request;

FIG. 2 is a high-level diagram showing key inputs generating multiple labor rates by service level;

FIG. 3 is a flowchart showing steps taken in calculating labor rates by service level corresponding to a platform;

FIG. 4 is a flowchart showing steps taken in calculating utilization indices corresponding to service levels;

FIG. 5 is a flowchart showing steps taken in calculating overtime indices corresponding to service levels;

FIG. 6 is a flowchart showing steps taken in calculating an overtime labor factor; and

FIG. 7 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

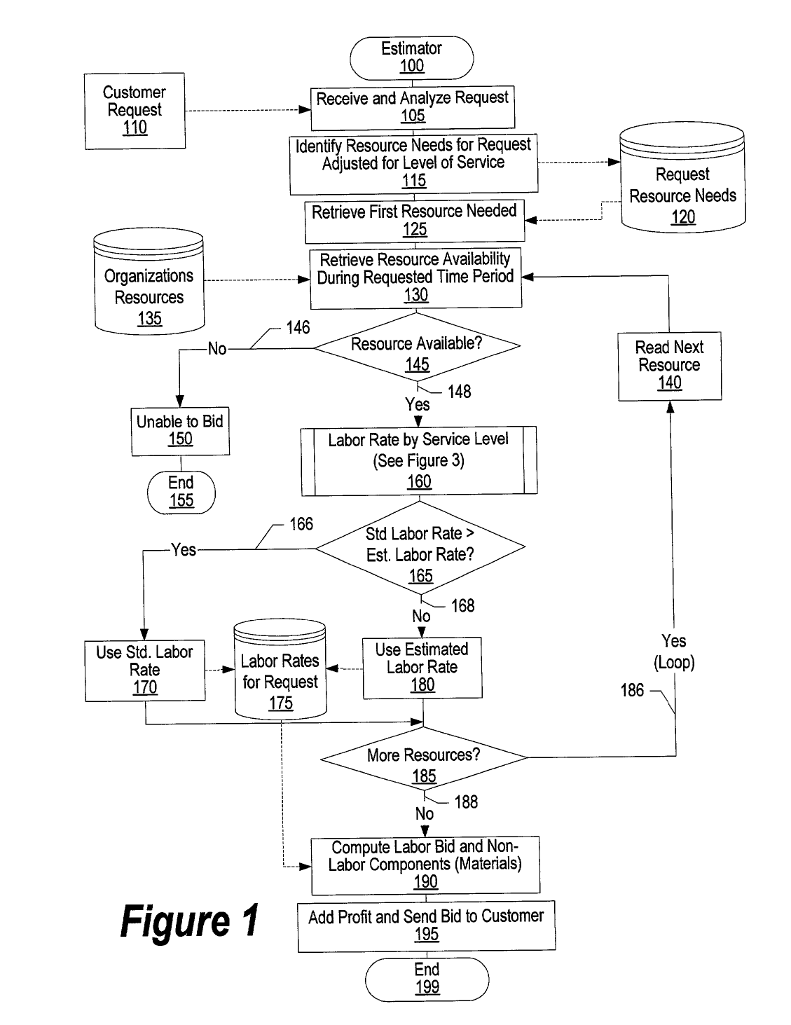

FIG. 1 is a flowchart showing steps taken in processing a customer request and responding to the request. Estimator processing commences at 100, whereupon customer request 110 is received and analyzed (step 105). Customer request 110 may be a request to manufacture a product or provide a service in particular timeframe. For example, a customer may request a service completed by the next business day.

Resources adjusted for a service level corresponding to the customer request are identified in request resource needs 120 (step 115). Request resource needs 120 may be stored in a non-volatile storage area, such as a computer hard drive. The first resource needed is retrieved from request resource needs 120 at step 125, and its availability is retrieved from organization resources 135 at step 130. Organization resources 135 includes the availability of resources in an organization and may be stored in a non-volatile storage area, such as a computer hard drive.

A determination is made as to the resource availability during corresponding timeframe of the customer request (decision 145). If the resource is not available, decision 145 branches to “No” branch 146 whereupon a bid is not generated (step 150), and processing ends at 155. For example, resources may be identified in the customer request that are preoccupied with other requests.

In another embodiment, a bid may be generated with available resources that may not completely match the customer request. However, the bid may be lower due to inconveniencing the customer. For example, the customer may request a product to be delivered overnight. For various reasons, resources to deliver the product overnight may not be available. Processing may determine the most comparable resource available that delivers the product in two business days and send a corresponding bid to the customer.

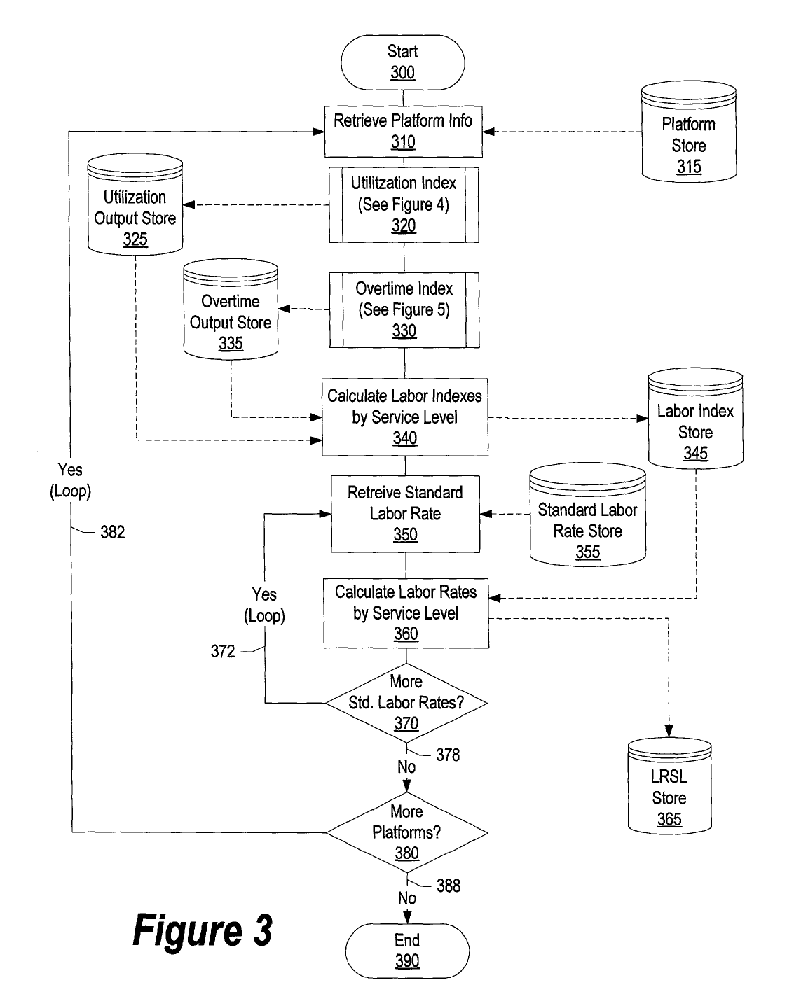

On the other hand, if resources are available for the timeframe corresponding to the customer request, decision 145 branches to “Yes” branch 148 whereupon labor rates are computed by service level (pre-defined process block 160, see FIG. 3 for further details). A determination is made as to whether a standard labor rate is higher than the computed estimate labor rate by service level (decision 165). For example, processing may compute an estimate labor rate by service level lower than the standard labor rate. In order to gain more revenue and profit, processing may choose the higher standard labor rate for bidding purposes.

If the standard labor rate is more than the estimate labor rate by service level, decision 165 branches to “No” branch 166 whereupon the standard labor rate is stored in labor rates for request 175 (step 170). Labor rates for request 175 may be stored in a non-volatile storage area, such as a computer hard drive.

On the other hand, if the estimate labor rate by service level is higher than the standard labor rate, decision 165 branches to “No” branch 168 whereupon The estimate labor rate by service level is stored in labor rates for request 175 (step 180).

A determination is made as to whether there are more resources required to generate a customer bid corresponding to the customer request (decision 185). If more resources are required, decision 185 branches to “Yes” branch 186 which loops back to read (step 140) and process the next resource requirement. This looping continues until there are no more resource requirements, at which point, decision 185 branches to “No” branch 188. A labor and non-labor component bid is computed based on labor rates for request 175 (step 190). Profit is added and the bid is sent to the customer at step 195. Processing ends at 199.

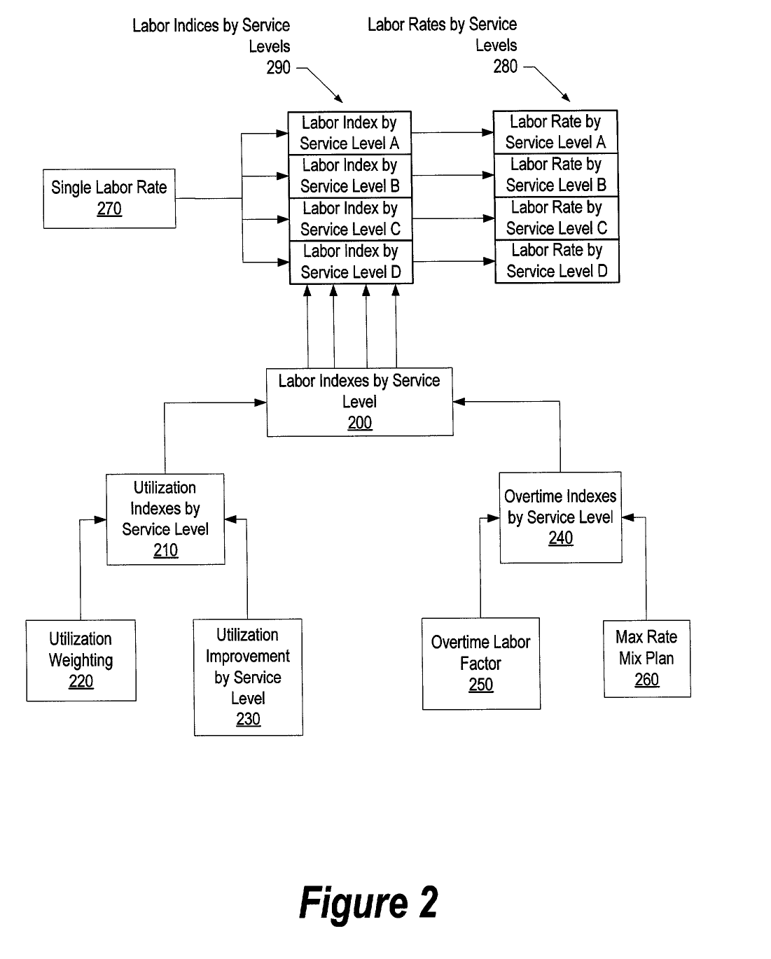

FIG. 2 is a high-level diagram showing fundamental inputs generating multiple labor rates by service level. Labor indices by service level 200 generates multiple labor indices that correspond to a particular service level. For example, one level of service is when a customer requests a product or service on the same day of his request. Another level of service is when a customer requests a product or service within one week of his request.

Multiple labor indices by service levels 290 are multiplied with single labor rate 270 to obtain multiple labor rates by service levels 280. Single labor rate 270 may be a current labor rate based on skill level, such as the hourly cost of a senior technician. Using the example above, the labor rate for a technician when a customer requests same day service may be higher than the labor rate for a technician when a customer requests service within one week.

Labor indices by service levels 200 are computed using two primary inputs. The two primary inputs are utilization indices by service levels 210 and overtime indices by service levels 240. Utilization indices by service levels 210 correspond to the utilization of a service level for a particular platform. Overtime indices by service levels 240 correspond to the increase or decrease in the amount of overtime for a particular service level

Utilization indices by service levels 210 are calculated using two primary inputs which are utilization weighting 220 and utilization improvement by service level 230. Utilization weighting 220 is an averaging factor for determining utilization indices for each service level. Utilization improvement by service level 230 corresponds to an increase in applied/billable hours.

Overtime indices by service level 240 are calculated using two primary inputs which are max rate mix plan 260 and overtime labor factor by service level 250. Max rate mix plan 260 is an averaging factor for determining overtime indices for each service level. Overtime labor factor by service level corresponds to the increase or decrease in the amount of overtime for a particular service level.

FIG. 3 is a flowchart showing steps taken in calculating labor rates by service level corresponding to a platform. Processing commences at 300, whereupon platform information is retrieved from platform store 315 (step 310). For example, platform information may include the labor requirements to build a particular product.

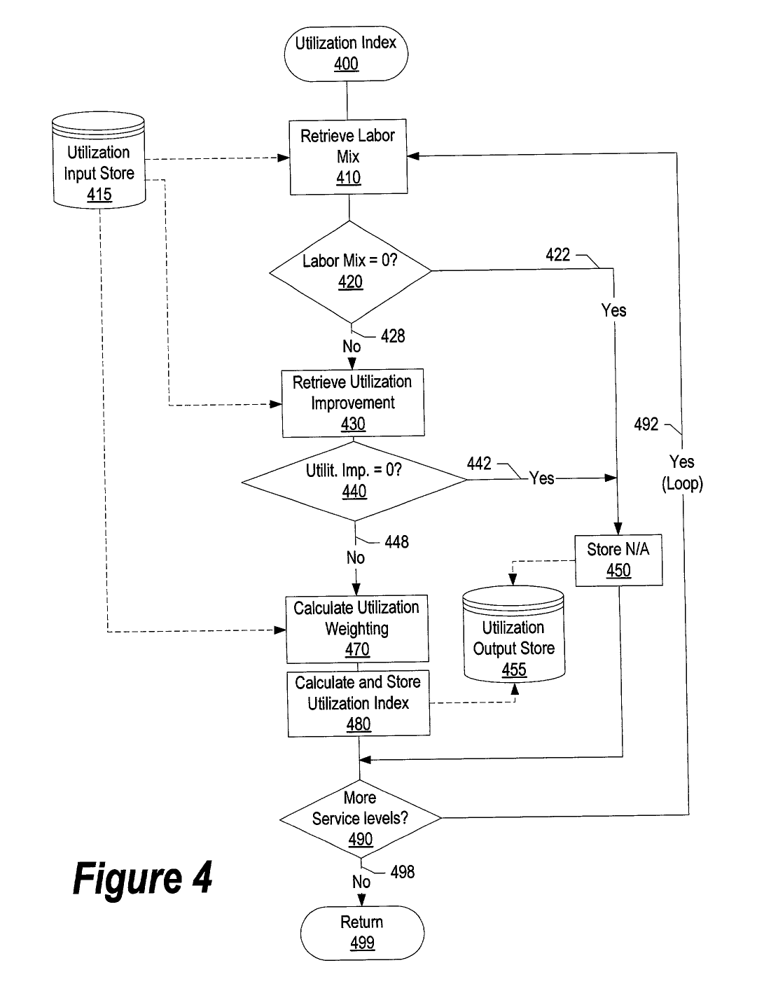

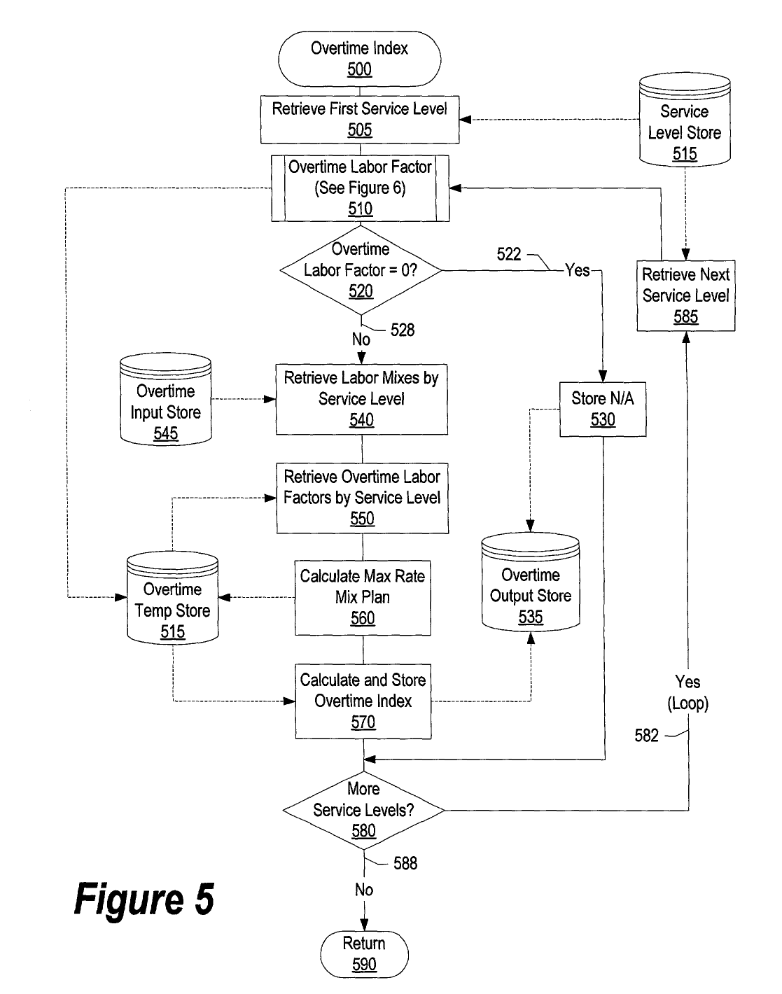

Utilization indices are generated and stored in utilization output store 325 (pre-defined process block 320, see FIG. 4 for further details). Overtime indices are generated and stored in overtime output store 335 (pre-defined process block 330, see FIG. 5 for further details).

Labor indices by service level are calculated and stored in labor index store 345 (step 340). The calculation uses utilization indices (UI) from utilization output store 325 and overtime indices (OI) from overtime output store 335. In one embodiment, labor indices by service level (LISL) are calculated using the following formula:

LISL=1+(UI−1)+(OI−1)

However, other formulas may be used which result in a similar labor index by service level.

Standard labor rates are retrieved from standard labor rate store 355 (step 350). Labor rates by service level are calculated and stored in LRSL store 365 at step 360. Labor rates by service level (LRSL) are calculated using standard labor rates (SLR) and labor indices by service level (LISL). In one embodiment, labor rates by service level are calculated using the following formula:

LRSL=SLR*LISL

However, other formulas may be used which result in a similar labor rate by service level.

A determination is made as to whether there are more standard labor rates (decision 370). If there are more standard labor rates, decision 370 branches to “Yes” branch 372 which loops back to retrieve and process the next standard labor rate. This looping continues until there are no more standard labor rates to process, at which point decision 370 branches to “No” branch 378.

A determination is made as to whether there are more platforms to process corresponding to the customer request (decision 380). If there are more platforms to process, decision 380 branches to “Yes” branch 382 which loops back to process the next platform. This looping continues until there are no more platforms to process, at which point decision 380 branches to “No” branch 388. Processing ends at 390.

FIG. 4 is a flowchart showing steps taken in calculating utilization indices corresponding to service levels. Processing commences at 400, whereupon a labor mix is retrieved from utilization input store 415 (step 410). A labor mix corresponds to the mix of service level for a particular platform or product line.

A determination is made as to whether the labor mix is zero or not available (decision 420). If the labor mix is zero or not available, decision 420 branches to “Yes” branch 422 whereupon “Not Available” is stored in utilization output store 455 (step 450). On the other hand, if the labor mix is not zero, decision 420 branches to “No” branch 428 whereupon a utilization improvement is retrieved. Utilization improvement corresponds to an increase in applied/billable hours.

A determination is made as to whether the utilization improvement is zero or not available (decision 440). If the utilization improvement is zero or not available, decision 440 branches to “yes” branch 442 whereupon “Not Available” is stored in utilization output store 455 (step 450). On the other hand, if the utilization improvement is not zero, decision 440 branches to “No” branch 448 whereupon a utilization weighting is calculated (step 470). In one embodiment, the utilization weighting (UW) uses each utilization improvement by service level (UMSL) and labor mix by service level (LMSL) and is calculated using the following formula:

UW=UMSL1*LMSL1+UMSL2*LMSL2+UMSLn*LMSLn

where 1,2,n correspond to service levels. However, other formulas may be used which result in a similar utilization weighting factor.

A utilization index by service level is calculated and stored in utilization output store 455 (step 480). The utilization index by service level uses the utilization weighting (UW), the utilization improvement by service level (UMSL), and a utilization unit factor (UUF). The UUF converts the UISL calculation whereby a 1% increase in utilization corresponds to a factor of 1 increase is UISL. In one embodiment, the utilization index by service level (UISL) is calculated using the following formula:

UISL=1+100*UUF*(UW−UMSL)

However, other formulas may be used which result in a similar utilization index by service level.

A determination is made as to whether there are more service levels to process (decision 490). If there are more service levels to process, decision 490 branches to “Yes” branch 492 which loops back to process the next service level. This looping continues until there are no more service levels to process, at which point decision 490 branches to “No” branch 498. Processing returns at 499.

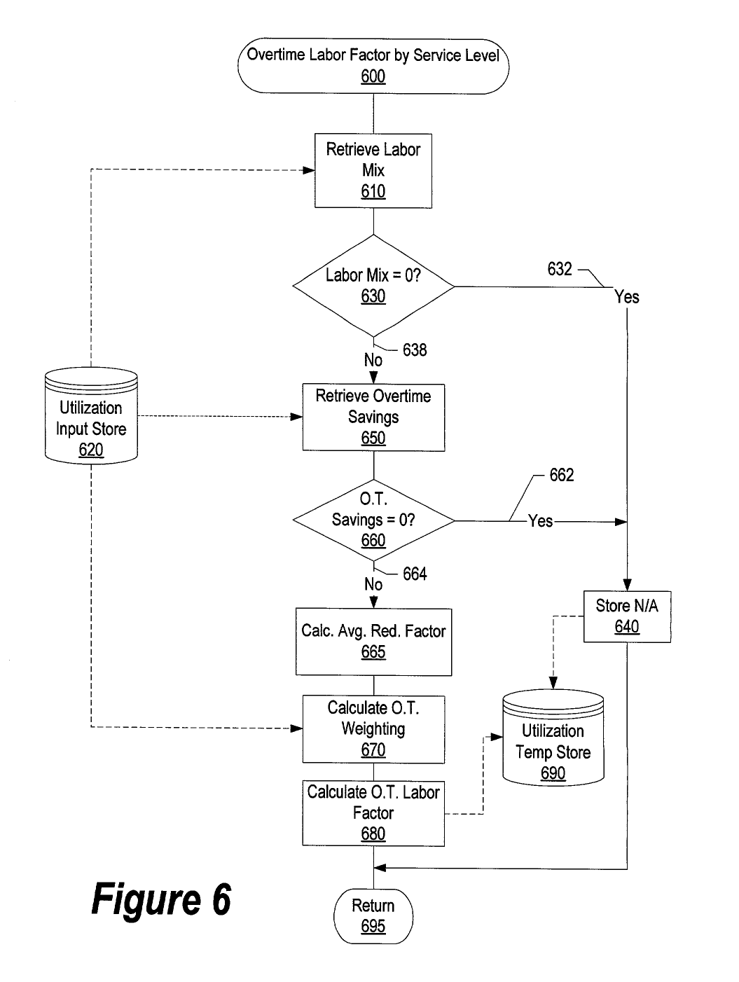

FIG. 5 is a flowchart showing steps taken in calculating overtime indices corresponding to service levels. Processing commences at 500, whereupon first service level is retrieved from service level store 515 (step 505). Service level store 515 may be stored in a non-volatile storage area, such as a computer hard drive. An overtime labor factor by service level is calculated and stored in overtime temp store 515 (pre-defined process block 510, see FIG. 6 for further details). A determination is made as to whether the overtime labor factor is zero or not available (decision 520). If the overtime labor factor is zero or not available, decision 520 branches to “Yes” branch 522 whereupon “Not Available” is stored in overtime output store 535 corresponding to the service level (step 530).

On the other hand, if the overtime labor factor is not zero (i.e. available), decision 520 branches to “No” branch 528 whereupon labor mixes by service level are retrieved from overtime input store 545 (step 540). Labor mixes by service level correspond to the service level mix for a particular platform.

Overtime labor factors by service level are retrieved from overtime temp store 515 (step 550). A max rate mix plan is calculated and stored in overtime temp store 515 (step 560). The max rate mix plan is a weighting factor in calculating an overtime index by service level. In one embodiment, the max rate mix plan (MRMP) uses labor mixes by service level (LMSL) and overtime labor factor by service level (OLFSL) and is calculated using the following formula:

MRMP=LMSL1*OLFSL1+LMSL2*OLFSL2+LMSLn*OFLSLn

where 1,2,n correspond to service levels. However, other formulas may be used which result in a similar max rate mix plan.

An overtime index by service level is calculated and stored in overtime output store 535 (step 570). In one embodiment, the overtime index by service level (OISL) uses the overtime labor factor by service level (OLFSL) and max rate mix plan (MRMP) and is calculated using the following formula:

OISL=OLFSL/MRMP

However, other formulas may be used which result in a similar overtime index by service level.

A determination is made as to whether there are more service levels to process (decision 580). If there are more service levels to process, decision 580 branches to “Yes” branch 582 which loops back to retrieve the next service level from service level store 515 (step 585) and process the next service level. This looping continues until there are no more service levels to process, at which point decision 580 branches to “No” branch 588 and processing returns at 590.

FIG. 6 is a flowchart showing steps taken in calculating an overtime labor factor by service level. Processing commences at 600, whereupon a labor rate mix corresponding to a platform is retrieved from utilization input store 620 (step 610). A determination is made as to whether the labor mix is zero or not available (decision 630). If the labor mix is zero or not available, decision 630 branches to “yes” branch 632 whereupon “Not Available” is stored in utilization temp store 690 (step 640).

On the other hand, if the labor mix is not zero, decision 630 branches to “No” branch 638 whereupon an overtime savings by service level is retrieved from utilization input store 620 (step 650). Overtime savings corresponds to a reduction of overtime from the maximum overtime service level. A determination is made as to whether the overtime savings by service level is zero or not available (decision 660). If the overtime savings by service level is zero or not available, decision 660 branches to “Yes” branch 662 whereupon “Not Available” is stored in utilization temp store 690 (step 640).

An average reduction factor (ARF) is calculated at step 665. In one embodiment, ARF is calculated using labor mix by service levels (LMSL) and overtime savings by service levels (OSSL) using the following formula:

ARF=LMSL1*OSSL1+LMSL2*OSSL2+LMSLn*OSSLn

where 1,2,n correspond to service levels. However, other formulas may be used that result in a similar average reduction factor.

An overtime weighting is calculated at step 670 which corresponds to an expected overtime, and uses ARF and a target max overtime (TMO). TMO corresponds to an estimated overtime for the highest response level of service. In one embodiment, the overtime weighting (OW) is calculated using the following formula:

OW=TMO*(1−ARF)

However, other formulas may be used that result in a similar overtime weighting.

An overtime labor factor by service level is calculated and stored in utilization temp store 690 (step 680). In one embodiment, the overtime labor factor by service level (OLFSL) uses target max overtime (TMO), plan overtime (PO), overtime weighting (OW), and overtime savings by service level (OSSL) and is calculated using the following formula:

OLFSL=1−(TMO*PO*OSSL/OW)

However, other formulas may be used that result in a similar overtime labor factor by service level. PO corresponds to the actual overtime a business is experiencing with the current market mix. Processing returns at 695.

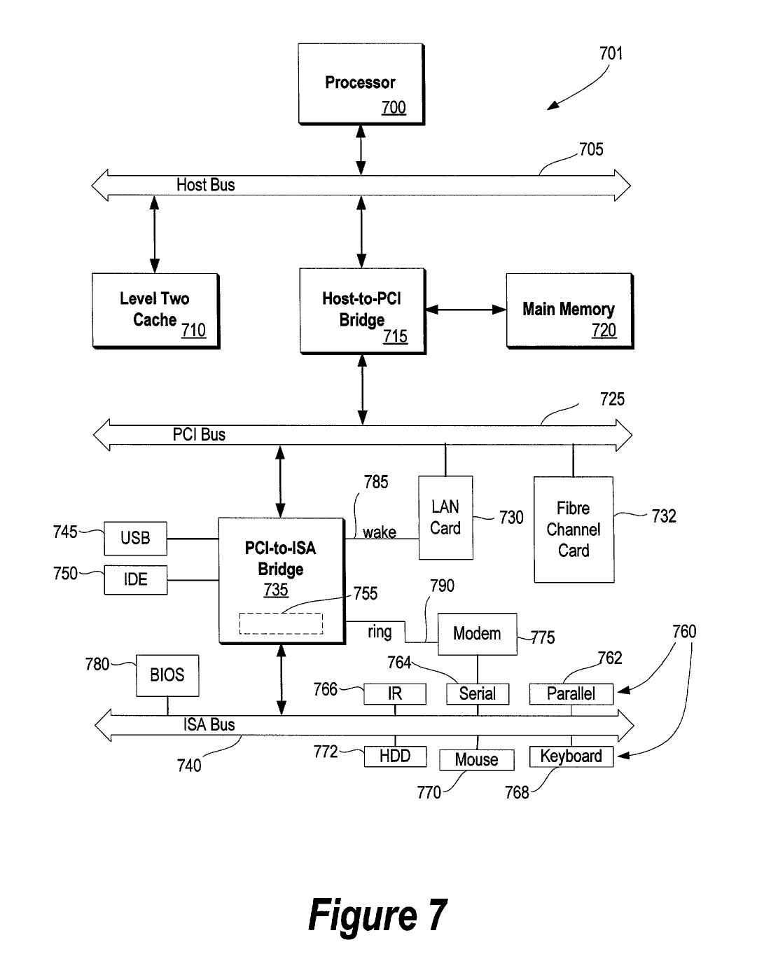

FIG. 7 illustrates information handling system 701 which is a simplified example of a computer system capable of performing the server and client operations described herein. Computer system 701 includes processor 700 which is coupled to host bus 705. A level two (L2) cache memory 710 is also coupled to the host bus 705. Host-to-PCI bridge 715 is coupled to main memory 720, includes cache memory and main memory control functions, and provides bus control to handle transfers among PCI bus 725, processor 700, L2 cache 710, main memory 720, and host bus 705. PCI bus 725 provides an interface for a variety of devices including, for example, LAN card 730. PCI-to-ISA bridge 735 provides bus control to handle transfers between PCI bus 725 and ISA bus 740, universal serial bus (USB) functionality 745, IDE device functionality 750, power management functionality 755, and can include other functional elements not shown, such as a real-time clock (RTC), DMA control, interrupt support, and system management bus support. Peripheral devices and input/output (I/O) devices can be attached to various interfaces 760 (e.g., parallel interface 762, serial interface 764, infrared (IR) interface 766, keyboard interface 768, mouse interface 770, and fixed disk (HDD) 772) coupled to ISA bus 740. Alternatively, many I/O devices can be accommodated by a super I/O controller (not shown) attached to ISA bus 740.

BIOS 780 is coupled to ISA bus 740, and incorporates the necessary processor executable code for a variety of low-level system functions and system boot functions. BIOS 780 can be stored in any computer readable medium, including magnetic storage media, optical storage media, flash memory, random access memory, read only memory, and communications media conveying signals encoding the instructions (e.g., signals from a network). In order to attach computer system 701 to another computer system to copy files over a network, LAN card 730 is coupled to PCI bus 725 and to PCI-to-ISA bridge 735. Similarly, to connect computer system 701 to an ISP to connect to the Internet using a telephone line connection, modem 775 is connected to serial port 764 and PCI-to-ISA Bridge 735.

While the computer system described in FIG. 7 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of estimating service oriented labor costs, said method comprising:
receiving a request from a requester;
identifying one or more resources and one or more service levels corresponding to the request;
calculating a labor rate by service level corresponding to the identification;
generating a response corresponding to the calculation; and
sending the response to the requester.

2. The method as described in claim 1 wherein the calculating further comprises:
calculating a utilization index by service level and an overtime index by service level; and
computing a labor index by service level corresponding to the utilization index by service level and the overtime index by service level.

3. The method as described in claim 2 wherein the utilization index by service level is calculated by multiplying a utilization unit factor by the difference between a utilization weight and a utilization improvement by service level.

4. The method as described in claim 2 wherein the overtime index by service level is calculated by dividing an overtime labor factor by a max rate mix plan.

5. The method as described in claim 1 further comprising:
determining whether the resource is available; and
sending a message to the requester based on the determination.

6. The method as described in claim 1 further comprising:
retrieving a standard labor rate;
comparing the standard labor rate with the labor rate by service level;
determining a labor rate based on the comparison; and
including the labor rate in the response.

7. The method as described in claim 1 wherein the message corresponds to one or more platforms.

8. An information handling system comprising:
one or more processors;
a memory accessible by the processors;
one or more nonvolatile storage devices accessible by the processors;
a labor cost estimating tool to estimate service oriented labor costs, the labor cost estimating tool including:
means for receiving a request from a requester;
means for identifying one or more resources and one or more service levels corresponding to the request;
means for calculating a labor rate by service level corresponding to the identification;
means for generating a response corresponding to the calculation; and
means for sending the response to the requester.

9. The information handling system as described in claim 8 wherein the means for calculating further comprises:
means for calculating a utilization index by service level and an overtime index by service level; and
means for computing a labor index by service level corresponding to the utilization index by service level and the overtime index by service level.

10. The information handling system as described in claim 9 wherein the utilization index by service level is calculated by multiplying a utilization unit factor by the difference between a utilization weight and a utilization improvement by service level.

11. The information handling system as described in claim 9 wherein the overtime index by service level is calculated by dividing an overtime labor factor by a max rate mix plan.

12. The information handling system as described in claim 8 further comprising:
means for determining whether the resource is available; and
means for sending a message to the requester based on the determination.

13. The information handling system as described in claim 8 further comprising:
means for retrieving a standard labor rate;
means for comparing the standard labor rate with the labor rate by service level;
means for determining a labor rate based on the comparison; and
means for including the labor rate in the response.

14. A computer program product stored in a computer operable media for estimating service oriented labor costs, said computer program product comprising:
means for identifying one or more resources and one or more service levels corresponding to the request;
means for calculating a labor rate by service level corresponding to the identification;
means for generating a response corresponding to the calculation; and
means for sending the response to the requester.

15. The method as described in claim 14 wherein the means for calculating further comprises:
means for calculating a utilization index by service level and an overtime index by service level; and
means for computing a labor index by service level corresponding to the utilization index by service level and the overtime index by service level.

16. The method as described in claim 15 wherein the utilization index by service level is calculated by multiplying a utilization unit factor by the difference between a utilization weight and a utilization improvement by service level.

17. The method as described in claim 15 wherein the overtime index by service level is calculated by dividing an overtime labor factor by a max rate mix plan.

18. The method as described in claim 14 further comprising:
means for determining whether the resource is available; and
means for sending a message to the requester based on the determination.

19. The method as described in claim 14 further comprising:
means for retrieving a standard labor rate;
means for comparing the standard labor rate with the labor rate by service level;
means for determining a labor rate based on the comparison; and
means for including the labor rate in the response.

20. The method as described in claim 14 wherein the message corresponds to one or more platforms.
